(19) United States
(12) Patent Application Publication
(10) Pub. No.: US 2002/0194601 A1
(43) Pub. Date: Dec. 19, 2002

(54) System, method and computer program product for cross technology monitoring, profiling and predictive caching in a peer to peer broadcasting and viewing framework

(76) Inventors: Ronald M. Perkes, Novato, CA (US); Peter I. Ohtaki, San Francisco, CA (US)

Correspondence Address: SQUIRE, SANDERS & DEMPSEY L.L.P, 600 HANSEN WAY, PALO ALTO, CA, 94304-1043, US

(21) Appl. No.: 10/206,874

(22) Filed: Jul. 26, 2002

Related U.S. Application Data
(63) Continuation-in-part of application No. 09/994,905, filed on Nov. 28, 2001.
(60) Provisional application No. 60/250,152, filed on Dec. 1, 2000.
(60) Provisional application No. 60/307,879, filed on Jul. 27, 2001.

(51) Int. Cl. G06F 13/00

(52) U.S. Cl. 725/44

(57) ABSTRACT

A system, method and computer program product are disclosed for delivering content utilizing a master agent. Content between at least one broadcasting agent and at least one viewing agent is matched based on identifications, permissions, and/or scheduling of the content. A peer to peer connection is provided via a network between at least one broadcasting agent and at least one viewing agent based the matched content. The matched content is transmitted to the viewing agent from the broadcasting agent via the network. The matched content is presented by the viewing agent to a viewer in a television channel format. In addition, embodiments of the present invention disclose a method of collecting, collating, organizing, analyzing and monetizing information about a consumer's computer usage and the usage of connected peripheral devices, using that information to select, download and coordinate the presentation of Advertising and Viewing Content and a method for the caching and remarriage of Advertising Content and Viewing Content on a consumer's computer. In addition, a method for managing the viewing of that downloaded content by the consumer is disclosed.

### CROSS-REFERENCE TO RELATED APPLICATION

This application is a continuation-in-part of U.S. application Ser. No. 09/994,905 entitled “CROSS TECHNOLOGY MONITORING PROFILING AND PREDICTIVE CACHING METHOD AND SYSTEM,” filed on Nov. 28, 2001, and which claims the benefit of U.S. Provisional Application No. 60/250,152, filed on Dec. 1, 2000. This application also claims the benefit of U.S. Provisional Application No. 60/307,879, entitled “PEER-TO-PEER TV BROADCASTING AND VIEWING,” filed on Jul. 27, 2001.

### BACKGROUND

The sweeping transformation to digital entertainment is providing increasing opportunities to advertisers and content providers to expand their viewing markets and make use of content inventory in a non-liner, consumer-targeted manner. These increased opportunities have made room for improved ways to develop information for targeted content distribution, and have opened the doors for improved content delivery and monetization methods.

While development of broadband delivery of Internet-based content is progressing, the field's technological innovations have not reached the point that allows simultaneous real-time downloading and viewing of digitally dense streaming media such as music and video. At the same time, consumer's expectations and demand for delivered digital content is growing, and with the spread of existing broadband delivery systems, will only increase further. In conjunction with this growing need are woefully inadequate methods for delivery of streaming media, with content technology companies chasing after technological answers to increase bandwidth in content delivery systems or further compress content to increase the amount that can be downloaded using current technology. While technological advancement is desired and inevitable, the increasing need in current technology-based broadband delivery makes waiting for these advances unfeasible. It is projected that 74 million broadband-equipped homes and 90 million digital television-equipped homes will be vying for digital content delivery by the year 2008, and the market is open to current technology based delivery of digital content. Currently developed broadband Internet telecommunications are DSL and its related ADSL, XDSL, IDSL (and other derivatives) and cable modems (DOCSIS). These modes of communication are “always on”. However, despite current broadband speeds, Internet congestion creates unreliable speeds and delivery quality. Absent immediate advances in broadband communications technology that expand existing capabilities in ways no one expects, simultaneous real-time delivery and viewing of content is a fact of the distant future.

Currently, consumer profiling is accomplished by either the receipt of information provided by the consumer, or monitoring the consumer's single technology usage, such as Internet, television or radio usage. Accordingly, those limited sources of information restrict the profiling capacity and result in a restricted view of the consumer's media consumption behavior.

In addition, the spread of digital content viewing has created a disconnect in the traditional marriage of advertisers and content providers. Increasing digital content and digital delivery of that content has resulted in the consumer's ability to avoid advertising, either by viewing only non commercial digital content, or skipping advertising via available technologies has driven advertiser's to look for new and more cost effective ways to expose their advertising content and content providers to learn new ways of paying for the creation of their content and monetization of their content inventories.

These factors all combine to intensify the need for new information collection and development, content delivery and content management mechanisms that enable content providers and advertisers to deliver an increased volume of more refined, targeted Advertising and Viewing Content to more consumers using current technology and communications infrastructure, in a manner that is consumer-centered and adaptable to future advances in technology. The method according to the present invention meets all of these criteria and presents an elegant, commercially and technologically feasible and immediate tool for increasing consumer interest in content, content delivery and the multitude of revenue sources that home delivery of content can provide.

### SUMMARY

The present invention is directed to one or more methods of relating to the collecting, collating, organizing, analyzing and monetizing information about a consumer's computer usage and the usage of connected peripheral devices, the use of that information to select, deliver and manage the presentation of Advertising and Viewing Content and a method for the caching, remarriage, and viewing of Advertising Content and Viewing Content on a consumer's computer. The methods fall into several categories, and are controlled by a software program residing on a consumer's computer (the “Client Software”):

Collection of Cross Technology Usage Information

Upon initiation of the consumer's involvement, the consumer applies to the Exchange Agent to be a participant in the Exchange Agent's membership base, and provides initial information regarding preferences and personal information. With the consumer's consent, continuous monitoring of the consumer's Cross Technology Usage is performed, providing a continuously developing picture of the consumer's viewing, listening and Internet surfing habits over a variety of computer capabilities and connected peripherals. That information (the “collected information”) is collected using the Client Software, which employs standard monitoring and collection techniques and disclosed techniques of information collection regarding the use, existence or non-existence of connected peripherals, components and capabilities.

Profiling and Content Selection

This method involves the implementation of standard and enhanced profiling and monitoring techniques to determine the interests of a consumer based upon the collected cross-technology information. Based upon the collected information and the categorization of that information, a “profile” of the consumer is developed. This profile is constantly updated and refined based on the consumers' usage. The resulting profile drives the targeted (predictive) selection of Viewing/Advertising Content and E-Commerce opportunities, tailoring them to a consumer's perceived interests.

Network Management

This method implements collection of selected content links, hard drive management and monitoring tools and content delivery, coordination, caching and presentation functions:

Delivery Scheduler

In order to accommodate the effects of limited bandwidth and/or general Internet traffic congestion in the downloading process, the present invention is directed to a method or methods, which optimize hard disk space and download scheduling. Through conventional means known to one of ordinary skill in the art, a server or servers which act as the focal point of the content delivery system interrogate the targeted consumer's computer to determine the amount of hard disk space available for downloads. The method gives the consumer the option to select the amount of hard disk space to allocate to the download and select the optimum time for performing the download to minimize interference with the consumers computing activities bandwidth availability, Internet traffic and content server capacity In the alternative, the consumer can allow automatic reservation of hard disk space and timing selection for those downloads. The resulting information is then used to further prioritize the content to be delivered to the point that downloads are configured to optimize space and download scheduling.

Content Manager

The method or methods of the present invention utilize software residing on the consumer's computer, which manages the display of downloaded content. Downloaded and/or partially downloaded content of different types, such as pay-per-view movies, Internet-delivered video, Internet-delivered digital music, television, Advertising Content and E-Commerce opportunities, are managed and displayed differently. In addition, this method enables the management and caching of content delivered to a consumer's computer from disparate content sources into a seamless, controlled presentation.

Guide

The method or methods of the present invention provide for the implementation of a Cross Technology Guide to the downloaded content, enabling the consumer to see the downloaded content displayed by the type of content, category or genre, title and other details, such as principal performers, run time and content provider. The guide may even select highlights or small portions of the downloaded video or audio content as “teasers” or “trailers”, to encourage the consumer to view that content. The consumer may pick and choose amongst the provided content and either preview or view the content, save the content for later viewing or delete the content.

The present invention is also directed to one or more methods of establishing, maintaining and receiving revenue from a subscription base or other service type that provides the services provided by the disclosed invention.

Embodiments of the present invention also provide for a system, method and computer program product for delivering content utilizing a master agent. Content between at least one broadcasting agent and at least one viewing agent is matched based on identifications, permissions, and/or scheduling of the content. A peer to peer connection is provided via a network between at least one broadcasting agent and at least one viewing agent based the matched content. The matched content is transmitted to the viewing agent from the broadcasting agent via the network. The matched content is presented by the viewing agent to a viewer in a television channel format.

In an embodiment of the present invention, the permissions and/or scheduling of the content may be assigned by the broadcasting agent. In another embodiment of the present invention, the matched content may be pulled from the broadcasting agent by the viewing agent. As another option, the matched content may be pushed by the broadcasting agent to the viewing agent. In yet another embodiment of the present invention, the broadcast agent may organize the content into broadcast segments and link the broadcast segments to one or more channels in the television viewing format. In such an embodiment, the matched content includes at least one broadcast segment and the viewer selects one of the channels to view the broadcast segment of the matched content. In even another embodiment, information about the viewer's use of a computer and of any connected peripherals to the computer may be collected and wherein the collected information may be used to provide content choices to the viewer provided via at least one of the network and any one of the connected peripherals.

### BRIEF DESCRIPTION OF THE DRAWINGS

FIG. 1 is a schematic diagram of a New/Existing User Site Access/Sign On Process used in an embodiment of the present invention;

FIG. 2 is a schematic diagram of the Application Process block of FIG. 1 in accordance with an embodiment of the present invention;

FIG. 3 is a diagram illustrating a Predictive Caching and Content Intermediation Process used in an embodiment of the present invention;

FIG. 4 is a diagram illustrating a Delivery Scheduler Component and Script used in an embodiment of the present invention;

FIG. 5 is a diagram illustrating a Content Manager Component and Script used in an embodiment of the present invention.

FIG. 6 is a diagram of a network architecture of a Broadcast Agent, Master Agent and Viewer Agent in accordance with an embodiment of the present invention;

FIG. 7 is a Broadcaster Schematic detailing functions performed by a Broadcast Agent (software operating on a first remote computer location) in accordance with an embodiment of the present invention

FIG. 8 is a Master Agent Schematic detailing functions performed by a Master Agent (operating on a server) in accordance with an embodiment of the present invention;

FIG. 9 is a Viewer Schematic detailing functions performed by a Viewer Agent (software operating on a second remote computer location) in accordance with an embodiment of the present invention;

FIG. 10 is a Viewer Schematic detailing additional functions performed by a Viewer Agent in accordance with an embodiment of the present invention;

FIG. 10A is a flowchart of a process for delivering content utilizing a master agent in accordance with an embodiment of the present invention;

FIG. 11 is a schematic diagram of an illustrative network system with a plurality of components in accordance with an embodiment of the present invention; and

FIG. 12 is a schematic diagram of a representative hardware environment in accordance with an embodiment of the present invention.

### DETAILED DESCRIPTION

Although the following detailed description contains many specifics for the purpose of illustration, one of ordinary skill in the art will appreciate that many variations and alterations to the following description are with in the scope of the invention. Accordingly, the following preferred embodiment of the invention is set forth without any loss of generality to, and without imposing limitations upon, the claimed invention.

A preferred embodiment of the invention includes a Exchange Agent operating one or more conventional web server machines with standard server software, one or more Advertising Content Providers (who provide only Advertising Content) operating one or more conventional web server machines with standard server software, one or more Viewing Content Providers (providing Viewing Content such as streaming video or music, movies or non streaming media such as e-books or photography) operating one or more conventional web server machines with standard server software. The servers and computer are connected to a computer network, such as the Internet, which enables the servers and computer to communicate with other servers, computers or Internet accessible Appliances via the Internet, Intranets and other networks, standard email, instant messaging and other communication technologies.

In the preferred embodiment of the invention, installed on the Exchange Agent's server or servers, and/or installed on a third party's server or servers and connected to the Exchange Agent's server or servers (or any combination thereof), is appropriate standard server applications and standard and enhanced Internet based monitoring software and profiling software. The Exchange Agent's server or servers, in conjunction with the monitoring and profiling software, operate to collect information about consumers' Cross Technology Usage (the “collected information”). As used herein, “Cross Technology Usage” refers to the use by the consumer of not only Internet and Internet delivered video and streaming and downloadable music (such as MP3s), gaming and television capabilities of their computer, but their usage of connected DVD and CD players, high definition television (HDTV) and broadcast television and the usage, existence and/or non-existence of other peripherals and components connected to their computers. The collected information can include the type of digital media the consumer views or listens to (Internet, movies, video, music, DVD, CD, TV/HDTV, etc.) and details about that digital material (i.e., genre, title, run time, artist, etc.), details regarding on-line viewing, such as URLs, on-line purchasing habits, and genre classifications of the consumer's on-line participatory habits, such as contests, advertising involvement and other on-line and interactive TV interactions. In addition, the monitoring software can collect information regarding what peripherals are and are not connected to the consumer's computer.

In addition, the present invention optionally utilizes at the consumer end a computing based Appliance with continuous Internet access, such as a DSL, wireless or Cable connection, but the present invention will accommodate any currently known or anticipated method of Internet connection. The appliance also allows for viewing of television programming, listening to streaming audio via speakers, viewing streaming video on a monitor and listening to CD-ROM or viewing DVD content from a CD-ROM/DVD player. Such a multimedia entertainment center that may be utilized in the present invention as an appliance may be one described in U.S. patent application Ser. No. 09/125,803, entitled MULTIMEDIA COMPUTER AND TELEVISION APPARATUS, which is incorporated in its entirety herein by reference. The appliance has loaded on it the Client Software.

Cross Technology Usage Collection/Profiling

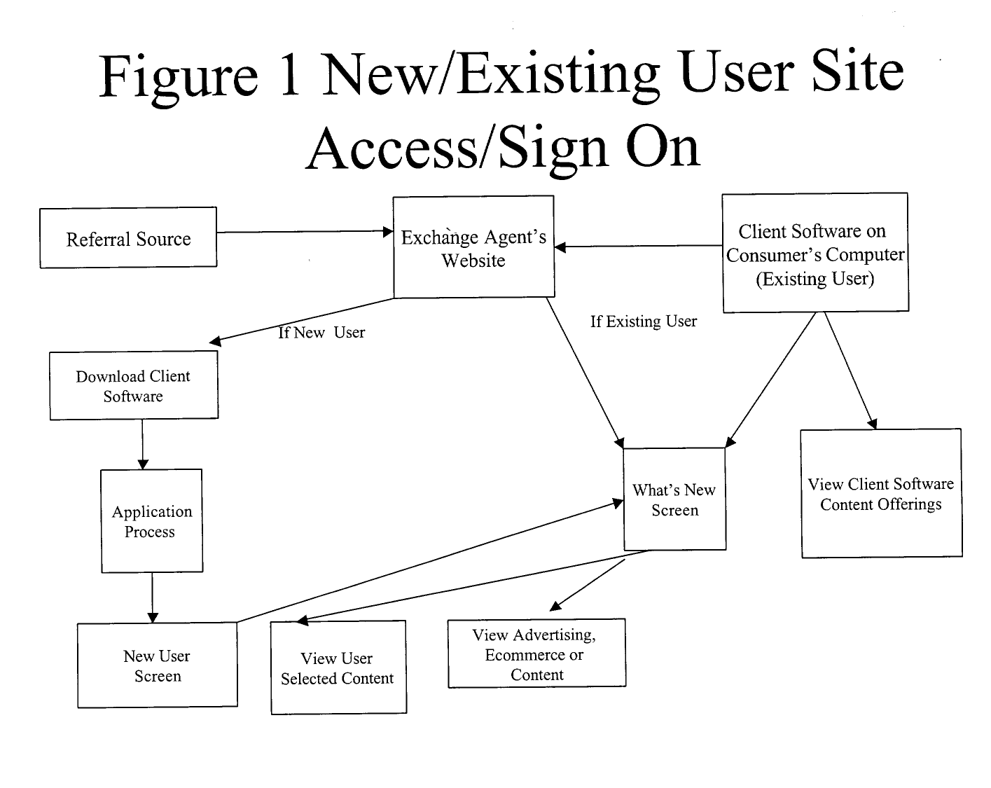

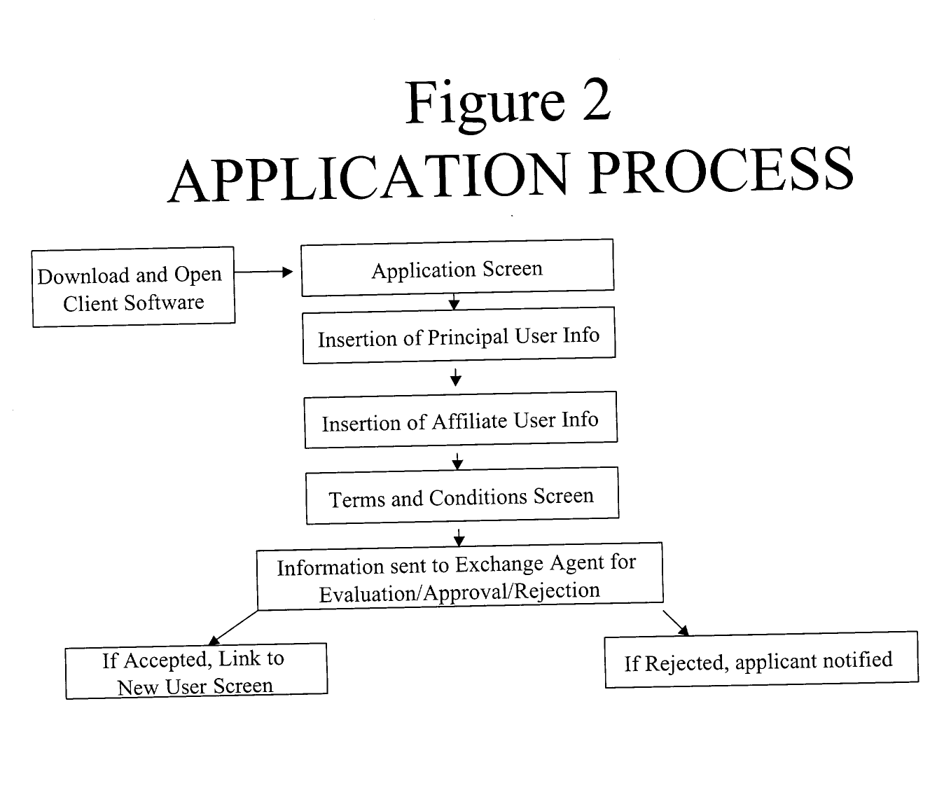

In the present invention, the consumer either receives the Client Software preloaded on a computer or consumer electronics equipment, or downloads the client Software from the Exchange Agent's website. The consumer engages in an application process, whereby the consumer will provide information such as their geographical location, sex, birthdate and personal interests, and apply to become a Member to the service. Additional information may be collected to further refine the profiling process. FIG. 1 shows a sequence of events relating to a user accessing and/or signing on to the service, according to the invention. FIG. 2 shows the sequence of events of the application process block of FIG. 1. In FIG. 1, if a user is a new user, such as one referred to the exchange agent by a referral source, the user accesses the exchange agent's website and downloads the client software. An application process is then executed from the downloaded client software. As shown in FIG. 2, the application process provides an application screen to the user, in which the principal user, as well as any affiliate users, can enter in information used as the basis of a “profile” on the user or users. The user is then presented with a “terms and conditions” screen, and the user-provided information is sent to the exchange agent for evaluation. Upon evaluation, the user is either approved or rejected. If approved, the user is provided with a link to a New User Screen; if rejected, the user is notified. Referring back to FIG. 1, an existing user accesses the exchange agent's website via the client software already present on the client's computer. The user can then view client software offerings, as well as “What's New” information provided on a “What's New” screen. The user can view selected content, advertising, or e-commerce information.

The Client Software on the consumer's computer collects, stores and transmits to the Exchange Agent's server or server's information regarding the consumer's Cross Technology Usage. In the present invention, the software takes the form of a Universal Media Player, which acts as a player for all digital entertainment viewed by the consumer. The Universal Media Player obtains logs on the web sites visited by the consumer, whereby the metatags obtained from those web sites are collected to obtain information regarding the types of web sites (e.g., sports, entertainment) the user prefers. The server also logs requests for content from the consumer. A log is also obtained on the television viewing habits of the consumer, by obtaining information obtained from the television signal itself or in combination with a TV-program database, for example, information that indicates the type of programming being watched (that information is also used by a V-chip, and may be encoded in the H-sync or V-sync interval of a television signal). Also, meta data, tags and other meta information embedded in CDs and DVDs played in the DVD/CD ROM Player are logged by the Universal Media Player. Using metatags associated with digital music files, and audio CD track and serial number information in combination with an audio CD database, music listening habits are also logged and the information transmitted to the server or servers. Other types of media that are accessed and played on the cross-media entertainment center may also be obtained and stored in a log, to further refine the profile of the consumer.

The Client Software running on the consumer's computer is designed to enable the consumer to program, store or bookmark favorite TV shows, downloadable/streaming video content, downloadable/streaming music content, video games and other content into sets of personalized preferences that cross the various types of viewing and listening technologies. These bookmarks are also collected and processed in the profiling function, thereby enhancing that function.

Using standard web-based monitoring, logging and collection software, the Exchange Agent's servers collect the collected information via the Internet. On the occasion of the first collection of that information, the information that is collected dates from the consumer's registration with the system. At the time of subsequent collections, the information collected is dated from the most recent previous collection. Collection of information can be done on a regular or irregular basis selected by the consumer or the server software.

The profiling software on the Exchange Agent's server or servers stores advertising, e-commerce and/or content and or content links with metatags, which refer to metadata, contained in the various advertising, E-commerce, content and content links stored on those servers. This metadata may, on all content, include the Title, Content Type, Description and Keywords applicable to that content item. Certain content Items may have additional metadata connected to them. For example, movies may have information regarding the stars and actors in a film, and information regarding the director, the existence of sequels, prequals, previous versions or later remakes of the film. Music items may list the artist, album Key Instruments (electric Guitar, piano, strings, etc.). Metadata can be further refined to include, for movies, the movie genre (classical, action, comedy, etc.); or, for music, the genre, chart standing, tempo of the music, decade of release and more subjective items such as beat, voice type and mood. E-commerce and advertising metadata will include purchase transaction information, additional information links, value and desired targeted demographic, among other desired information.

The information collected regarding the consumer's Cross Technology Usage is then categorized according to the content types referred to above, collated and delivered to the profiling software maintained by the Exchange Agent or a third party service. Content items may be part of multiple categories. For example, which processes the information and compares it to one or more databases of content grouped in similar categories and classifications.

The present invention uses the collected information and implements standard and enhanced profiling and monitoring techniques to determine the interests of a consumer. Broadcast television and digital content, including but not limited to streaming video and music, DVD, audio CDs, Advertising Content and E-Commerce opportunities, are categorized into groups of varying degrees of refinement. For instance, sports, movies, music and television may form a first tier set of categories. Further refinement may develop sub categories such as baseball, action movies, and country music and television comedy. Increases in the number of participants in the profiling process permits even further refinement of the groups. In the preferred embodiment of the invention, the profiling groups will be refined to the point where the consumer will be delivered more specific content, such as San Francisco Giants baseball-related content, Bruce Willis action movies, N'Sync music, videos and concerts and original Star Trek television episodes. For example, audio items may be further divided into music, and then into classical, instrumental, pop and other more refined categories. In addition, items can be associated together on a more subjective and flexible basis. For instance, certain advertising (i.e. beer or popcorn commercials) can be associated with sporting events. The collected information and categorized content are processed to select content that meets the consumer's perceived interests (the “selected content”).

A further refinement of the profiling process will also permit the pushing to the consumer of targeted advertising and e-commerce opportunities, and will create a targeted and precisely defined consumer base rich with opportunities for advertising and e-commerce.

Selected content may either be Viewing Content, Listening content, and Advertising Content or E-Commerce opportunities. Selected content may either be based in the Exchange Agent's, Advertiser's or Content provider's servers. In the present invention, the Exchange Agent's servers evaluates the consumer's perceived preferences and, using predictive models, determines content types that might be of interest to the consumer. Selected Content is in the form of links to that content on the content provider's website. The present invention downloads those links to the consumer's computer for management by the Content Manger function of the software on the consumer's computer.

In the present invention, selected content links that are downloaded are managed in several ways as described herein. It may appear as a link, in a preview format, as a full download or as a partial “near on demand” download. The selected content is then further analyzed and narrowed based upon implementation of the Network Management tools disclosed herein. As related to the present invention, the Network Management tools analyze the configuration of the targeted consumer's computer configuration to determine the storage availability based on the extent of available hard drive storage and thus the size of the proposed download. In addition, the present invention analyzes the consumer's Internet access habits and bandwidth availability to determine the best time to schedule a download of the selected content and selected content links. Giving the targeted consumer the ability to set preferences as to the amount of content to be downloaded and the download time are optional features of this method. In addition, the method can be implemented to enable, as an optional function, the automatic evaluation of storage availability and download timing, and to enable the consumer to initiate an immediate download and either storage for future viewing or viewing of the content at the point a sufficient amount of the content is downloaded to ensure a reliable uninterrupted viewing experience.

The Delivery Scheduler Script

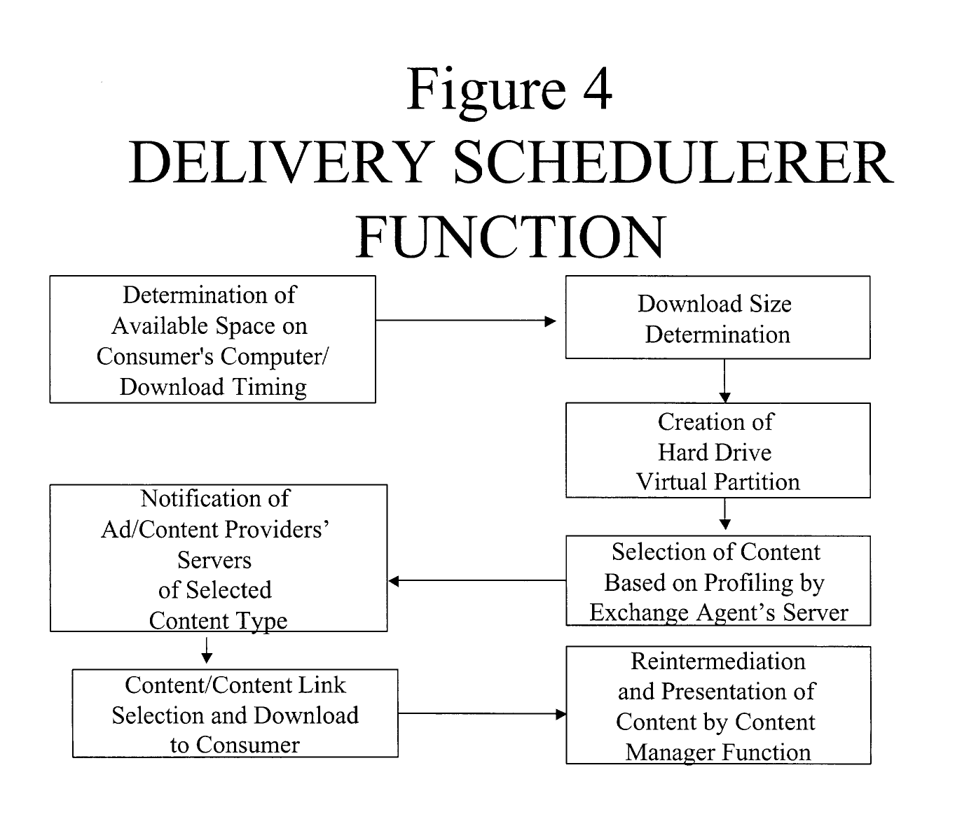

FIG. 4 shows the various steps involved for the Delivery Scheduler function. In the preferred embodiment of the invention, the Delivery Scheduler function software resides on the central server or servers, and is activated at predetermined times to access a particular consumer's computer or a number of consumer's computers. The Delivery Scheduler function determines the amount of free hard disk space on the consumer's computer, and determines the amount of space to allocate to a download to that hard drive using one of two methods. In one method, after being presented with the amount of available hard disk space on the computer, the consumer can select the amount of hard drive space to allocate to receiving delivered content. Using that method, the amount of space available for future downloads will be restricted to the consumer's selected amount. In another method, the consumer allows the Delivery Scheduler function to apply an algorithm to determine a measurement of the size of an acceptable download. That algorithm is: A×B=C, where A is the available hard disk drive space, B is a percentage of that available space determined by the consumers system configuration and considerations related to hard drive performance as it nears full capacity, and C is the acceptable download size.

Based either upon the selection by the consumer or application of the above algorithm, the method then creates a virtual partition of the hard drive or uses any one of several methods to reserve the selected amount of hard drive space, which methods are known to those skilled in the art. This reservation may be fixed for all future downloads or fluctuate (if determined by The Delivery Scheduler function on a download by download basis).

The Delivery Scheduler function then analyzes the selected content links and, using the priority of the consumer's perceived interest in the type and the size of the selected content, eliminates from the download queue lower priority or excessively large content according to the priorities established by the profiling method. For instance, if a consumer has 1.5 gigabits of available hard disk space at the time of the Delivery Scheduler hard drive scan (Algorithm value A), and the value of B is 85%, The Delivery Scheduler function calculates a download size of 1.275 gigabits.

Assume, for example, that the selected content and selected content links are made up of two (2) music videos consisting of 80.5 megabytes, a movie of 970 megabytes, a television episode sized at 255 megabytes and Messaging/Advertising Content/E-commerce opportunities consisting of 120 megabytes (a total of 1.4255 gigabits). The Delivery Scheduler function will first determine if an acceptable download will accommodate downloading all of the selected content and selected content links. In the example, the total download size is 1.4255 gigabits. Since this figure is below the acceptable download calculation (1.5×85%=1.275), The Delivery Scheduler function will first eliminate the lowest priority content item and determine that the balance falls within the acceptable download size. If, after eliminating the lowest priority content, the Delivery Scheduler function determines that the remaining content does not fall within the acceptable download parameters, it will eliminate the next lowest priority content, and continue with this process until the remaining content size is within the acceptable download size.

In the present invention, once the Delivery Scheduler function determines that the remaining content falls within the acceptable download size, it will calculate the difference between the acceptable download size and the actual size of the remaining content. If there is no difference, the Delivery Scheduler function will initiate the download process. If a difference is calculated, the Delivery Scheduler function will go to the previously eliminated content, in priority from the last eliminated to the first eliminated, and recover that content until the difference between the acceptable download size and the actual size of the remaining content is consumed or as nearly consumed as possible in light of the acceptable download size and remaining content. This process ensures that the consumer always receives the largest amount of content in the download.

The Delivery Scheduler function also allows for the delivery to a consumer's computer of updates and improvements to the software that controls the functions of the invention. Such downloads are either done separately so as to maximize the content that can be downloaded, or take priority over content being downloaded.

The Delivery Scheduler function, using the well known functions of the consumer's computer, determines whether the consumer is engaged in using the computer at the time of access and uses the history of recent logged activity and past history stored in the consumers' profile to determine the optimum time for the download and also examines Internet network to determine optimum time when bandwidth is available. An algorithm is applied to this information, which results in a command to either proceed with or delay the download.

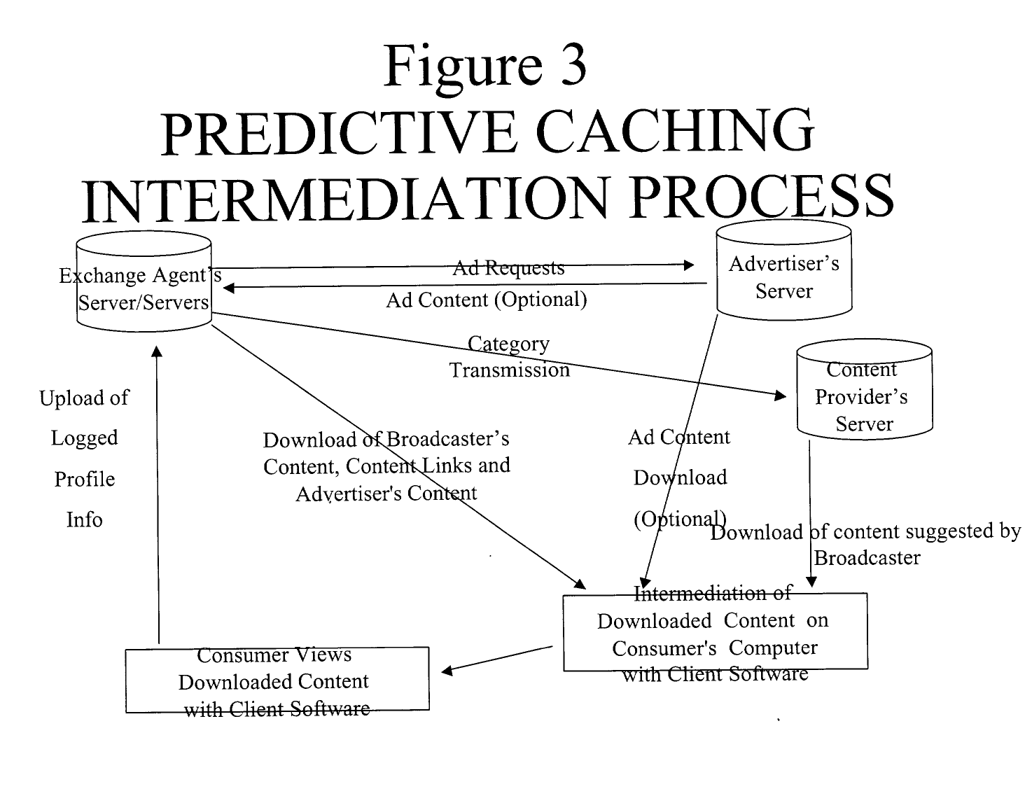

FIG. 3 shows various steps involved in a predictive caching function that may be utilized in the present invention. Predictive Caching, working in combination with The Delivery Scheduler function, is a method of nonlinear digital broadcasting of selected content and content links, the coordination of delivery of that content from disparate sources to, and the organization, control and presentation of selected content and selected content links on, a consumer's computer. Relying on standard and enhanced profiling techniques to select and download to a consumer's computer targeted content and content links from a Exchange Agent's server, the method also enables the Exchange Agent's server or servers to request from Advertiser's servers that Advertising Content that meets the perceived interests of the consumer (see FIG. 3). In addition, the Exchange Agent's server or severs downloads onto the consumer's computer links to Viewing or Listening Content that is perceived to be of interest to the Consumer. Those links are to targeted content from a separate and distinct Viewing Content Providers server. The method instructs the consumer's computer to both download content from the Viewing/Listening Content Provider's server and to organize the delivery of the content from an Exchange Agent's servers and Viewing Content from one or more Content Provider's servers. Once the downloading of all content is complete, the Content manager function organizes the content into a seamless presentation viewable on the consumer's computer in a preselected format.

If the download includes content from disparate servers, the Delivery Scheduler function sequentially requests downloads information from each of those servers to the consumer's hard drive, so that only one server at a time is downloading into the consumer's computer memory. FIG. 3 also shows the consumer/consumer's computer providing profile information to the exchange agent server or servers, which is used by that server to determine appropriate ads to sent to the user, as well as content obtained from a content provider's server. The downloaded content and/or ad information is provided to the user by way of the content manager function, which allows the user to view downloaded content by way of the client software.

The Content Manager Function.

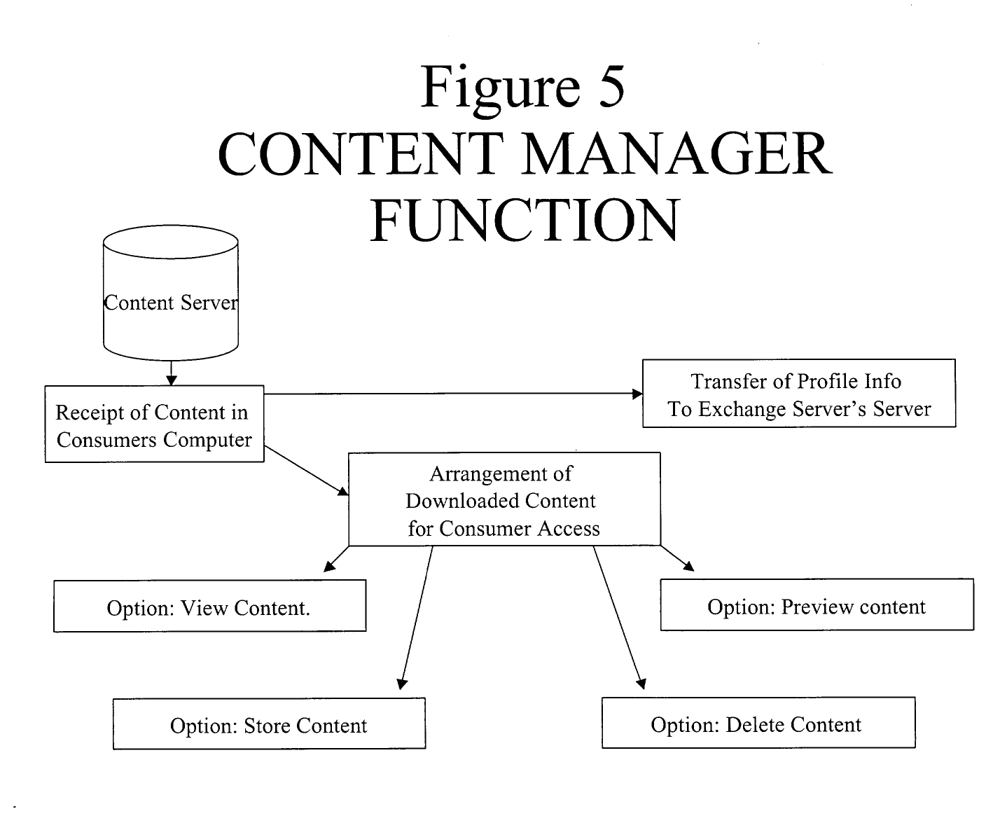

Another component in the preferred embodiment is the Content Manager function. Elements of the Content Manager function are shown in FIG. 5. The content manager function facilitates the receipt, storage and manipulation of the downloaded content once the consumer's computer receives it. This computer function accepts the proceed or delay download command from the Delivery Scheduler function, aggregates the selected content links processed by the profiling software, and initiates the download of that content via the Internet, using widely know methods for downloading of content from one sever on the Internet to another. In addition, the Content Manager notifies any affiliated Content Providers to download their selected content as directed by the results of the profiling process. The Content Manager then stores and organizes the delivered content on the Consumer's hard drive for display.

The content that is downloaded may appear to the consumer in one of several ways. The consumer may be presented with a description of the selected content and a hyperlink which, when clicked on by the consumer mouse or pointing device, directs the consumer's browser to that link, or the selected content may be fully downloaded, in the case of Ad Content or content of a smaller bandwidth. In addition, the consumer may be presented with “near-on-demand” formatted content (the download of a certain portion of lengthy content, such as a pay per view movie or webcast, whose selection to view triggers a showing of the downloaded portion of the content and simultaneous download of the remaining portion of the content or initiates downloading for future viewing). The present invention also enables the presentation of off-line referrals to content (such as concerts DVDs, audio CDs or contests). Referring now to FIG. 5, once the downloaded content has been arranged by the content manager function, the user is provided with several options: a) preview the content, b) view the content, c) store the content, d) delete the content or e) leave the content as delivered.

The present invention also enables the consumer to view a listing, or guide, of the delivered content accompanied by additional information regarding that content, and to control the viewing of the content, targeted messaging and advertising opportunities. The guide, unlike traditional, single technology, linear guides, displays Cross Technology content opportunities, such as DVD, and CD, CD-Rom, broadcast TV streaming, near-on-demand and on-demand Video, Music, audio, games and any other media capable of being played or displayed on a computer, as well as Advertising Content and E-Commerce opportunities. The guide integrates these disparate technologies into one seamless, digital entertainment guide for all uses.

In the process of the selection of content to be delivered, the Content Manager collects certain data regarding the content (“content data”), including but not limited to the type of content, category or genre, content title and other details, such as principal performers, run time and content provider. Additional content data such as delivery terms may also be collected. For example, content data information regarding a delivered pay-per-view encrypted movie, audio or music video will also include the view terms (pay-per-view price, period in which the content may be viewed, if limited, and time when the content will self delete), or the terms under which the consumer may indefinitely save the content. For example, this method enables copyright owners to place ownership, resale and distribution restrictions on the delivery, much the same as those, which accompany the traditional sale or rental of movies, videos and CDs/DVDs.

These different types of content must be managed differently (i.e. ensuring display perimeters, compliance with encryption guidelines and appropriate deletion of and selected content links once it is viewed or after a specific period of time).

In an embodiment of the invention, the content data is delivered to and formatted by a personalized content guide (PCG). This is a computer program, which collects the content data into a ticker type electronic programming guide format (“guide”), which enables the consumer to review, preview and otherwise customize the manner in which the guide displays the delivered content. The content data is set forth in any one of several formats; the consumer is able to select the desired format from any one of multiple supplied formats. The guide will, on the first download, display the information in a default format, which is the order of the consumer's perceived interest as delivered by The Delivery Scheduler function. When the consumer opens the guide, they will be prompted to review the format of the guide and be given an opportunity to select a default display format, in which case all future guides will be presented in that format. For instance, instead of the priority, or order, in which The Delivery Scheduler function delivers the content, the consumer may want to see all movies displayed first, or all audio selections displayed first. In addition, the method enables the consumer to switch between different formats whenever they are in the guide, whether or not a default format was selected.

The present invention enables the consumer to select one of several ways to view the guide and delivered content. For example, the consumer may choose to view the content displayed in the guide in a different format than the default format and may customize the guide by adding or subtracting categories or genres, and by bookmaking favorite content. The consumer may choose to preview previewable content, immediately view the content, save content that is allowed to be saved, or delete consent of no interest to the consumer. The present invention enables the consumer to preview or view the delivered content, or selected individual items of the delivered content, in any desired order by selecting the appropriate button displayed in the guide in the order the content is to be previewed/viewed. If the consumer makes more hard drive space available, the consumer may also initiate the delivery of lower priority content that was eliminated in the content selection process, in which case the Delivery Scheduler script will begin again as to that content. If the consumer takes no action regarding the content, it will remain on the consumer's computer, to be deleted according to the parameters set forth in the guide. The guide is then used to play whatever content the consumer selects amongst the downloaded content.

Navigation of the guide may be based on consumer-established preferences, profiling, genre/category, recommendation or any combination thereof. The method of navigation may be by traditional means such as keyboard or pointer device, or other means such as voice or 3D, or any method that permits control and selection of displayed items. The Guide may also be “skinnable” where consumers may select many alternative designs.

Depending on the type of content that is delivered, the consumer may be able to “Preview” the content, if previews are provided or allowed by the content provider. This method is implemented by the placing of a “Preview” button on the guide, or distinguishing the content (i.e. displaying the previewable content data in a distinguishing color, in the same manner that the color blue is used to denote a hyperlink on a web page).

The present invention also allows the user to select the content they want to preview or view, and the resulting selection opens a Universal Media Player (UMP). The method integrates the wide variety of media players now available (and can be modified to play future media types), such as streaming video plug-ins (QuickTime, Windows Media Player RealPlayer, etc.), DVD Player, TV/HDTV player and streaming music players (MP3) into what appears to the consumer as an integrated user interface with consistent navigation metaphors and controls (such as play, stop, forward, favorites, etc.). The consumer's selection is automatically detected and opens the media player required to play the type of media selected. If the Consumer activates the particular method implemented, the Guide will launch either a proprietary media player or any one of several widely distributed and well-known media player formats (such as Windows Media Player, RealPlayer or Apple's QuickTime Media Player), and display the preview of the content. For instance, if the content is a movie or video, the guide might play highlights of that content or a content provider supplied movie/video trailer may be shown. If the content is audio content, the guide might play highlights of the content, such as a portion of a musical piece or speech. These “teasers” would be used to encourage the consumer to play the previewed content, thereby increasing pay per views.

The present invention enables the Exchange Agent to deliver to the consumer additional content in the form of messages, Advertising Content and E-Commerce opportunities. Messages may contain such information regarding targeted announcements of deliverable content or E-Commerce opportunities, previews of available deliverable content, contest opportunities, upcoming events and e-commerce opportunities. Advertising Content and E-Commerce opportunities may also appear. Targeted messages are those that are have perceived interest to the consumer. Targeted announcements are more likely to be viewed by consumers, thereby increasing the chances of action taken by the consumer (i.e. purchase of pay per view content, viewing of ads, engaging in e-commerce). In addition, the method allows for the delivery of announcements about the service itself For instance, The Delivery Scheduler function may initiate a notice that there is not enough drive space to deliver content at the next scheduled delivery, advising the consumer to make additional hard disk space available. The message may also make announcements of events such as software upgrades, new features and feature improvements and new content partners.

Use of targeted content delivery can result in both targeted delivery of Viewing Content (such as pay-per-view movies, music and other media) and Advertising content. For instance, the delivery of targeted Advertising Content to be viewed, the delivery of targeted e-commerce opportunities (on- or off-line opportunities to purchase products and services), and consumer participation activities (such as contests, drawings and other activities requiring more consumer involvement), in addition to all other standard methods for monetizing targeted audiences, can be implemented using standard techniques and the methods described herein to develop revenue sources.

Peer-to-Peer TV Broadcasting and Viewing

The streaming media industry, while achieving breakthroughs in technology, characterized by greater levels of compression, improved qualities of audio and video, has none-the-less failed at achieving certain standards of ubiquity and seamless operation such as is typical of legacy entertainment systems such as television and radio. Users until now have located then played web-based digital audio and video media through a web-based search, or a digital entertainment or streaming media portal, methods designed for desktop PC internet users. Users of MP3 digital audio files have found comparatively more convenient methods to locate, download, then play digital music, however even these methods are still focused on the desktop PC user and not optimized for the easy “sit-back” style of usage to which living room entertainment users are accustomed.

The result has been slowness in the adoption rates of newer forms of digital media such as digital video, digital audio and digital still photos “new media”, by the mainstream of entertainment users. The applicant believes slow adoption, in part, to be a consequence of user's frustrating or futile efforts to locate then play newer forms of digital audio and digital video. Users accustomed to a lifetime of instant access to television channels and radio stations teamed with the convenience of a remote control, expect their entertainment products to instantly deliver entertainment as they “surf” from a broad selection of choices.

Embodiments of the present invention may serve to bridge the gap between heavily entrenched traditional media usage behavior and new media usage by creating a delivery system that allows new media to be instantly served to the user in a fashion very similar to that which television and radio users are accustomed to. Application of the present invention results in instantaneous TV-like usability of newer forms of digital media such as digital video, digital audio and digital still photos. In addition, the application of the present invention provides a method for new media publication and distribution of a great body of media created and stored on users home systems at the “edge” of the internet including media created by other users, rather than the standard content creation industries. Content may also be user or community-created content (e.g., the “Mill Valley AYSO-soccer video channel”) as well as ‘professional’ content (e.g., the “Snow boarding channel”) This way embodiments of the present invention may be used by a community to share their DV content with like-minded people.

An additional application of the present invention allows a server to perform identification, permission verification, scheduling and file transfer initiation functions that permit the secure and timely transfer of the Broadcast Segments. The resulting new media broadcasts in accordance with the present invention offer a true alternative to the commercial television and radio broadcasts.

Embodiments of the present invention provide for a system., method and computer program product for organizing, publishing and distributing (collectively “Broadcasting”), then locating, taking delivery, and displaying (collectively “Viewing”) new forms of digital media, such as digital audio, digital video, digital photos (collectively “New Media”) that aggregately result in seamless, easily navigable viewing and listening experience similar to that which a television currently provides. Involved may be at least two User operated computing devices on which reside the invention, which may be a software program (“the Program”) and at least one server (Master Agent). Users of the invention may be viewers and listeners of New Media (“Viewers”), or distributors of New Media (“Broadcasters”) (the Program allows one to be either a Viewer or a Broadcaster). Using a remote control to perform functions of the Program in an easy to navigate environment, Broadcasters may create a collection that includes one or more digital media types for broadcast using a variety of third-party applications such as are commonplace on the personal computer, or through special client software tools that allow the Broadcaster to select an organize digital media files in a chosen order, insert text or graphics or other similar objects, and to save and store that organized media (“Broadcast Segment”) and link it to a specific button on the user interface of the software program, which button is known as a “Channel, which operates as a residence for the Broadcast Segment. Included in this process may be a drag and drop assembly of media clips, the assigning of permissions (for example, without limitation, push/pull permissions, download scheduling, modification and distribution permissions). A Broadcast Segment may be an original collection of digital media clips or an update to a previously broadcast Segment.

Embodiments of the present invention may allow the Broadcaster to grant certain permissions to allow Viewers to view, and schedule the delivery of, the Broadcast Segment. Broadcasters can store and broadcast one or more Broadcast Segments into one or more Channels at a time. Viewers can be selected either individually or by interest group, work project group, community or organization or any other desired grouping. The organized media (“Broadcast Segment”) is then linked by the Broadcaster to a Broadcaster identified Channel”. The Broadcaster then initiates an Intention to transmit Notice, which is either sent to the Master Agent or, alternatively, can be sent directly to the Viewer. The on line/off line status of the Viewers computer is determined by the Master Agent, and if on line, the viewer is provided certain information about the Broadcast Segment, such as the Broadcaster's Name, size of the download, and the Broadcaster's description of the Broadcast Segment's content. The Viewer is then given the option to accept or refuse the download of the Broadcast Segment. Once the Broadcast Segment is downloaded, the program creates a Channel on the Viewer's computer that corresponds to the Broadcaster's selected Channel name. The Viewer may see one or more such Channels, depending on the number of previous downloads and the number of previous broadcasts initiated by the Viewer. The Viewer, using a remote control, can preview the Channels on the Viewers computer much like television viewers “surf” television broadcast channels. Channels are then selected for viewing. The Channels may be reflected in a Channel Guide, which provides information including, but not limited to, the Channel name, Channel identifier (either that provided by the Broadcaster or the Viewer), Broadcast Segment size and run time, download date and a certain amount of Viewer or Broadcaster discretionary information, such as a Broadcaster or Viewer selected description of the Broadcast Segment within the Channel.

The Viewer may select one or more channels, driven by the applicant's client server software, to view the Broadcast Segment. Viewers may store and queue Viewer-selected Broadcast Segments into one or more channels. The “surfing” experience may be enhanced by the implementation of a caching method on the Viewers computer that automatically inserts into the cache a predetermined portion of each channel, and the right of the Viewer to designate “active” channels (often viewed or new channels) and “inactive” (channels viewed less often, or channels the Viewer wishes to store”). Additional control may be given to Viewers to determine maximum cache and Channel size, download scheduling and the extent of storage media that is to be allocated to the download of Broadcast segments. In an embodiment of the present invention, the content stored in the cache may be of a format capable of being stored on various IP-addressable devices within a home network. For example, if digital photos, video or MP3s are stored on a user's desktop PC in the user's den, and the user wishes to watch or listen on to the content via their living room TV using a MSFT X-Box, Sony set-top, etc. all connected to a home network.

As an option, embodiments of the present invention may include some or all of the following characteristics and functions:

Broadcasters identify content they wish to broadcast (“Broadcast Segment”).

Broadcasters identify digital media clips already stored on their computer and organize them into a seamless continuous Broadcast Segment, and insertion of text, graphics and other objects and incorporation of them into a “Personal Channel”. Personal Channels may be organized by genre, family, interest, subject, project or any other classification.

Each “personal channel” would be given a name by the Broadcaster, and would have that same name on a Viewer's computing device one it was delivered.

Establishing Permissions using distribution lists, rights and schedulings. For instance, The Broadcaster may give the Viewers computing device-varying degrees of permission to further manipulate the Broadcast Segment, which rights could range between absolutely no right to manipulate the digital media to the same rights that the Broadcaster has.

Preparation for distribution utilizing web server technology.

Distribution would be by broadcasting versus basic web-publishing.

Broadcasters location and readiness are known by the Master Agent running on peer-to-peer server/router

Broadcasters and Viewers are known to the Master Agent by an optional alias or by a URL.

Broadcasters can select Viewers, schedule distribution and set permissions.

Viewers can select/reject Broadcasters and set scheduling.

Master Agent may act as tool to verify identity permissions granted, scheduling and to initiate a download command to the Broadcaster's computer.

The Broadcaster can elect to broadcast or “push” the Broadcast Segment to the Viewer, or may give to a Viewer the right to “pull” the channel to the Viewer's computer.

A Master Agent Server facilitates the broadcast

Peer to peer connections are established by the master agent in conjunction with a client agent running on both the Broadcaster's software and the Viewer's software.

A Broadcasting Agent communicates to the Master Agent, running on the Server, that it has a Broadcast Segment ready to go to one or more Viewers,

The Master Agent seeks out the selected Viewers, identified by alias, URL or other identifier, and verifies the on line/off line status and identity/granted permissions for that Viewer.

A Viewing Agent communicates to the Master Agent that it has an interest in some or all of the Broadcast Segment.

Upon identifying a Broadcaster ready to broadcast and a Viewer authorized and scheduled to receive that Broadcast the Master Agent establishes/initiates a peer-to-peer communications link between Broadcaster and Viewer on which the Broadcast Segment from the Broadcaster's system is sent to and stored on the hard-drive or caching mechanism on the Viewer's system.

The Broadcast Segment and identifying Channel are transferred to the recipient Viewer's computing device.

The resulting Broadcast can occur in the background behind other foreground activities.

Optionally, the Broadcast can utilize only excess bandwidth so as to not impact on the quality of other functions running in the foreground.

Optionally, error checking insures completeness of transmissions. As a further option, error checking may insert an “incomplete” programming message in cases where a Broadcast is not fully received by the Viewer's system. As an additional option, a Broadcast can continue through to completion even after interruption or reboot.

Viewers select one or more Personal Channels to View the Broadcast Segment

A function of the client software (Viewer Agent) offers one or more television-like “channels” from in which the Viewer may store and queue digital materials sent to the Viewer by the Broadcaster.

The client software has “channel” controls allowing the consumer to select and switch between different “personal channels”. And, depending on the permissions given, manipulate the digital media in any “personal channel”, and to provide permissions for the further delivery of or accessibility to the channel media by one or more preselected recipient Viewers or group of persons who fit a certain profile or are identified as belonging to a certain group.

A Viewer may also elect to rearrange or interlace comments into a Broadcast Segment and rebroadcast the modified Broadcast Segment to the original Broadcaster or group to whom the original broadcast was made.

Creating a Television-Like New Media Channel for the Viewer

Embodiments of the present invention may extend television-like attributes to viewing of Broadcast Segments that viewers of television expect from a television such as:

Easy to use controls/remote control,

Broadcast Segments organized into a “channel” structure,

the Viewer's ability to instantly select programming through a channel guide/navigator,

instant playback when selected by a Viewer, continuous or “seamless” playback of Media files in a Broadcast Segment.

A content-selection engine, such as a Universal Media Player engine, instantly plays digital audio and digital video content

Instant television-like playback may be made possible by a Media Player engine, such as the Universal Media Player (UMP) engine manufactured by Lumenati, Inc., or by other engines made by other companies that allow one to receive and play digital audio and/or digital video content from a network such as the Internet. The UMP is a hand-held remote control device that allows various selections to be made by a Viewer so as to retrieve content by way of a computer (and monitor) utilized by Viewer, whereby the content is retrieved from a network such as the Internet.

The present invention utilizes the UMP or other suitable engine to power the playback of the Broadcast Segment, whereby the UMP is operated by the Viewer.

Once loaded into memory, the engine allows instant media selections and playback without any lag time such as is normally experienced by the user when moving between dissimilar forms of media.

The resulting changes from one program to the next occur in a very short period of time, such as in a fraction of one second.

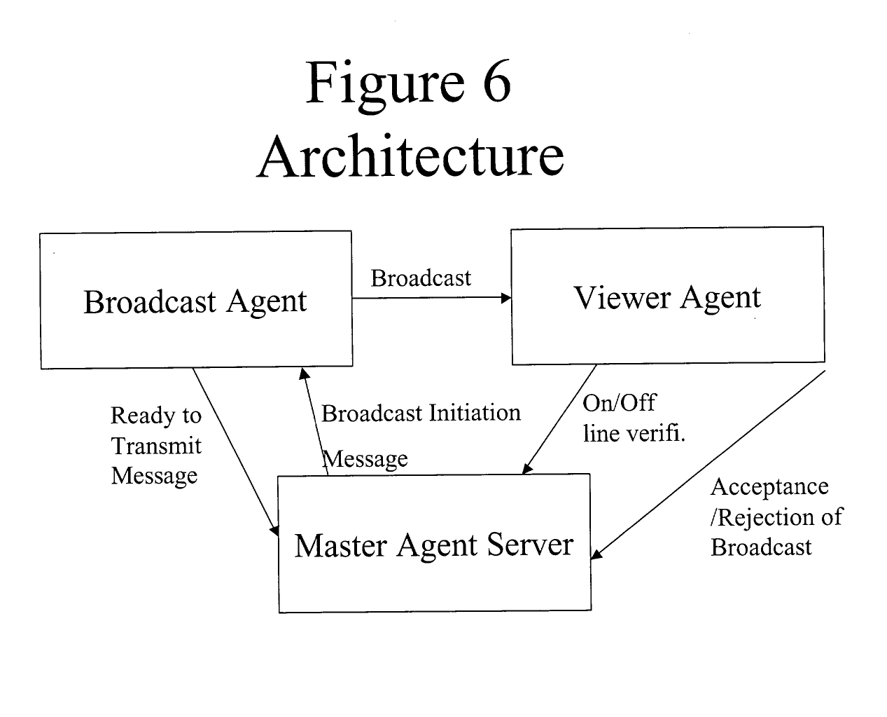

FIG. 6 shows an architecture that includes a Broadcast Agent operating at a remote device, a Viewer Agent operating at another remote device, and a Master Agent which is operating on a server in accordance with an embodiment of the present invention. The Broadcast Agent, Viewer Agent and Master Agent are communicatively connected to each other by way of a network, such as by way of the Internet. The Broadcast Agent, the Master Agent, and the Viewer Agent are software applications running on computers at the Broadcaster, the Server, and the Viewer, respectively.

The Broadcast Agent sends an Intention to Broadcast signal to the Master Agent Server. That signal can alternatively also be sent directly to the Viewer Agent as well. The Viewer Agent is presented with an option to accept the content to be provided by the Broadcast Agent, and if the Viewer Agent desires to accept the content, it will send an Acceptance of Broadcast signal to the Master Agent. If it does not desire to accept the content, it will send a Rejection of Broadcast signal to the Master Agent. If the Master Agent receives the Acceptance of Broadcast signal from the Viewer Agent, the Master Agent Server responds by sending a Broadcast Initiation signal to the Broadcast Agent, and then the Broadcast Agent can start to send content, as a Broadcast Segment, to the Viewer Agent. Also shown in FIG. 6 is an On/Off Line Verification for the Viewer Agent to notify the Master Agent when it is operating.

In a “pull” configuration of information transfer between a Broadcaster and a Viewer, the Viewer agent is presented with a menu of various content provided by various Broadcasters. When a Viewer desires to viewer content provided by a specific Broadcaster, it notifies the Master Agent by way of a menu selection made by the Viewer on a monitor of a computer operated by the Viewer. The Viewer Agent presents the menu to the Viewer, and also presents the menu selection to the Master Agent. The Master Agent then sets up a peer-to-peer content transmission between the specific Broadcaster and the Viewer.

In a “push” configuration of information transfer between a Broadcaster and a Viewer, the Viewer is presented with an Intention to Broadcast Notification sent directly from the Broadcast Agent. If the Viewer desires to receive the content, it makes a selection on a menu presented on the monitor of the computer operated by the Viewer, and the Viewer Agent notifies the Master Agent of this selection. The Master Agent then sets up a peer-to-peer content transmission between the Broadcaster and the Viewer.

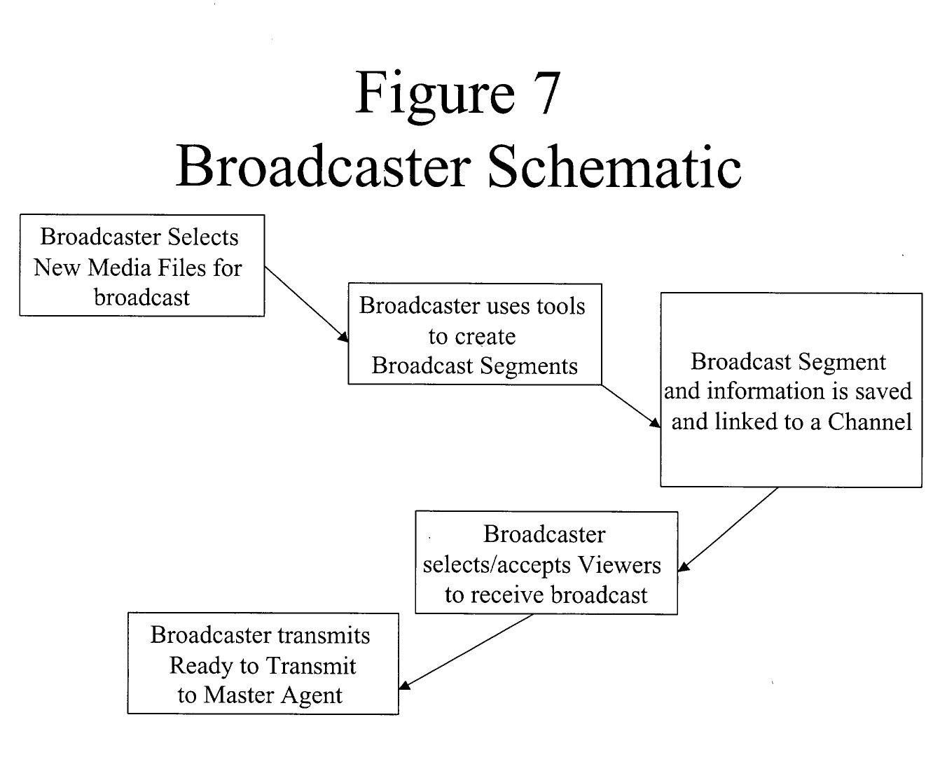

FIG. 7 shows a schematic of the Broadcast Agent functions in accordance with an embodiment of the present invention. The Broadcaster selects files, such as New Media files, streaming video and/or streaming audio, for broadcast. The Broadcaster uses software tools to create Broadcast Segments, in a manner known to those skilled in the art. The Broadcast Segments are saved with a link to a Broadcast Channel. The Broadcaster selects/accepts Viewers to receive broadcasts. For example, the Broadcaster can select only Viewers of a particular age category, if the Broadcast Segments are of a mature nature. The Broadcaster transmits Intention to Broadcast signals to the Master Agent (or alternatively also to the Viewer Agent).

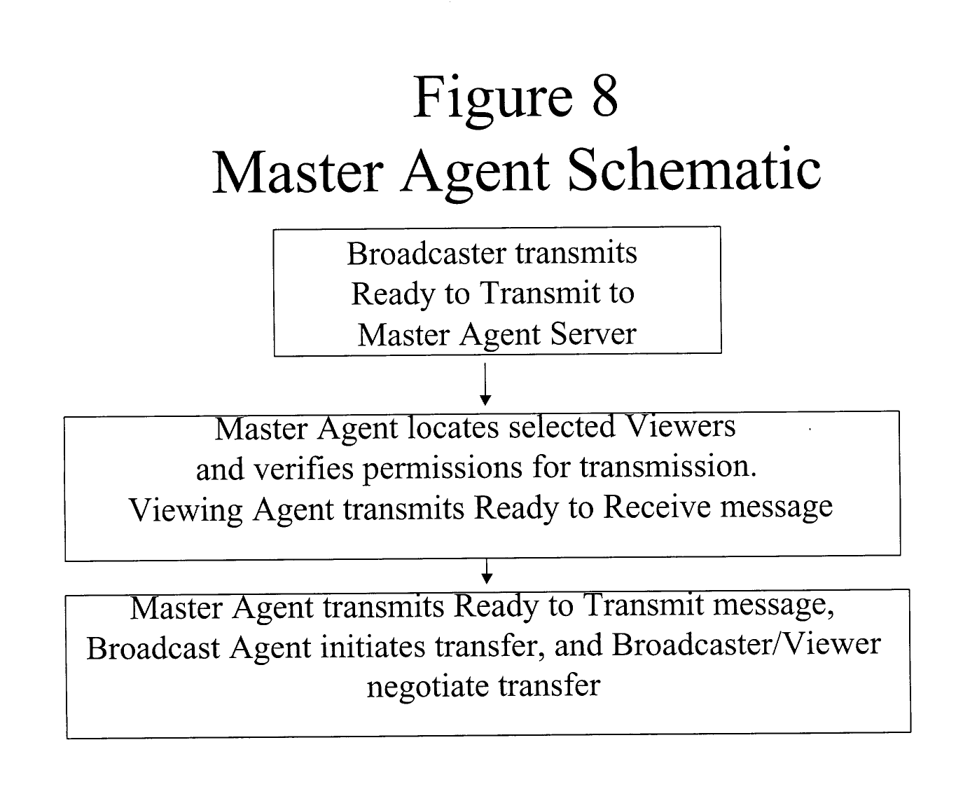

FIG. 8 shows a schematic of the Master Agent functions in accordance with an embodiment of the present invention. The Master Agent receives Intention to Broadcast signals sent from the Broadcaster Agent. The Master Agent perceives/processes transmission, locates selected Viewers, and seeks approval for transmission from the Viewer Agent. The Viewer Agent receives an Intention to Broadcast Notification, sent by the Master Agent and/or sent directly from the Broadcaster Agent.

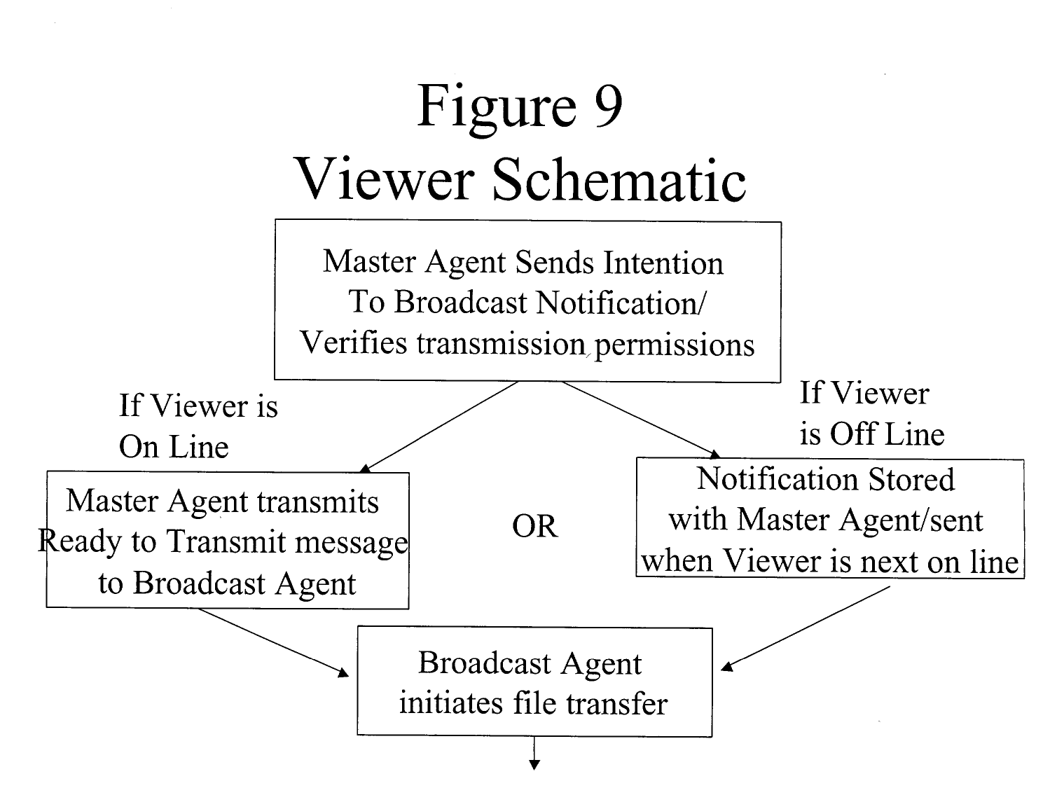

FIG. 9 shows a schematic of the Viewer Agent functions in accordance with an embodiment of the present invention. As explained above with reference to FIG. 8, the Master Agent sends Intention to Broadcast Notification and verifies transmission permissions. If the Viewer is On-Line, the Viewer is notified of the Intention to Broadcast, as output by the Master Agent. If the Viewer is Off-Line, the Intention to Broadcast Notification is stored with the Master Agent for future notification to the Viewer Agent (that is, when the Viewer Agent goes back On-Line). In either case, when the Viewer Agent is On-Line, it is given the option to view, store, or refuse the Broadcast (as output by the Broadcaster Agent).

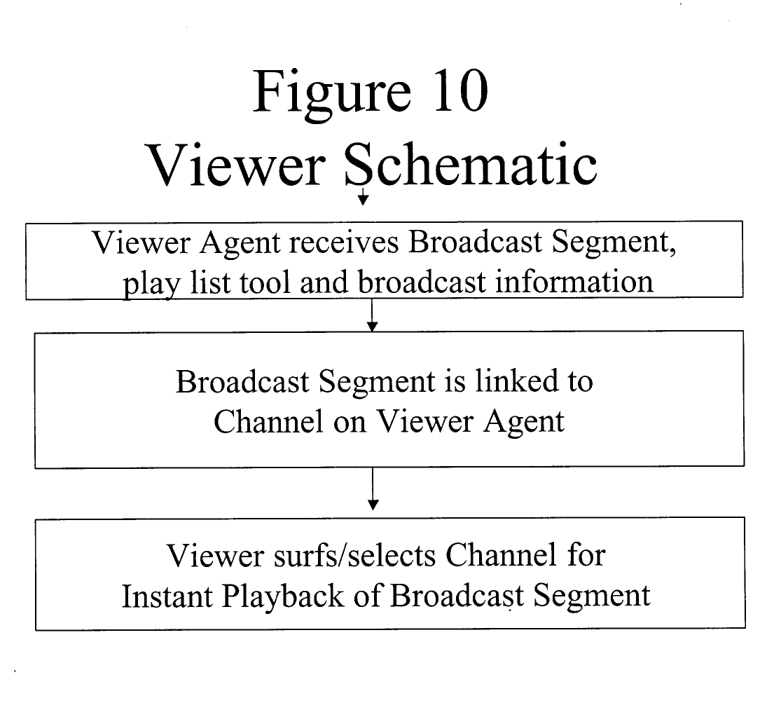

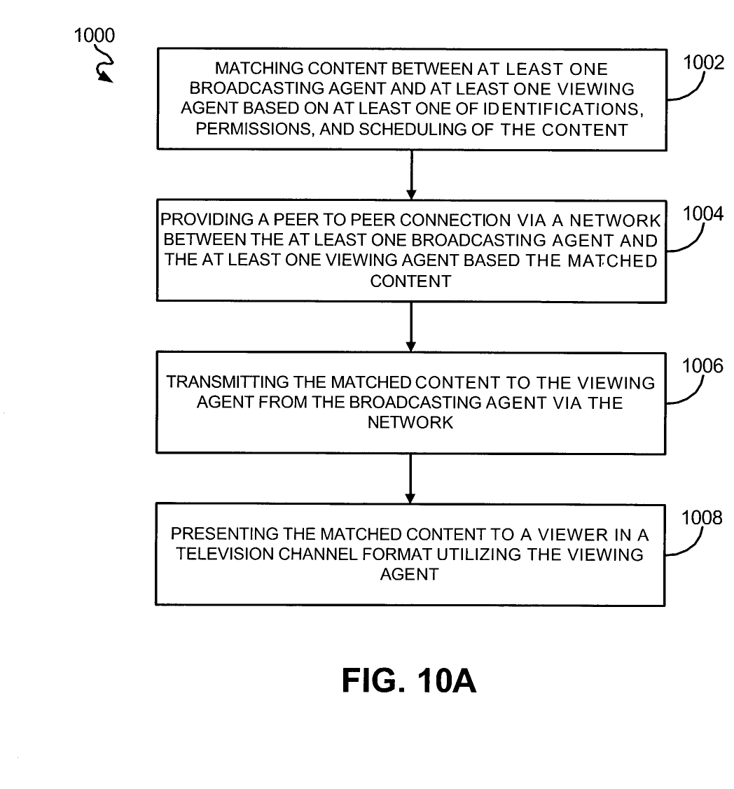

FIG. 10 shows a schematic of additional functions of the Viewer Agent. If the Viewer desires to obtain the Broadcast, the Viewer chooses to view or store the Broadcast (by selecting menu choices presented on a monitor used by the Viewer, as presented by the Viewer Agent). The Master Agent receives this information, and advises the Broadcast Agent accordingly, and the content download is initiated as a peer-to-peer data transfer between the Broadcast Agent and the Viewer Agent. The Viewer Agent receives the Broadcast, and views or stores it by way of the Viewer Agent.

FIG. 10A is a flowchart of a process 1000 for delivering content utilizing a master agent in accordance with an embodiment of the present invention. Content between at least one broadcasting agent and at least one viewing agent is matched based on identifications, permissions, and/or scheduling of the content in operation 1002. A peer to peer connection is provided via a network between at least one broadcasting agent and at least one viewing agent based the matched content in operation 1004. The matched content is transmitted to the viewing agent from the broadcasting agent via the network in operation 1006. The matched content is presented by the viewing agent to a viewer in a television channel format in operation 1008.

In an embodiment of the present invention, the permissions and/or scheduling of the content may be assigned by the broadcasting agent. In another embodiment of the present invention, the matched content may be pulled from the broadcasting agent by the viewing agent. As another option, the matched content may be pushed by the broadcasting agent to the viewing agent. In yet another embodiment of the present invention, the broadcast agent may organize the content into broadcast segments and link the broadcast segments to one or more channels in the television viewing format. In such an embodiment, the matched content includes at least one broadcast segment and the viewer selects one of the channels to view the broadcast segment of the matched content. In even another embodiment, information about the viewer's use of a computer and of any connected peripherals to the computer may be collected and wherein the collected information may be used to provide content choices to the viewer provided via at least one of the network and any one of the connected peripherals.

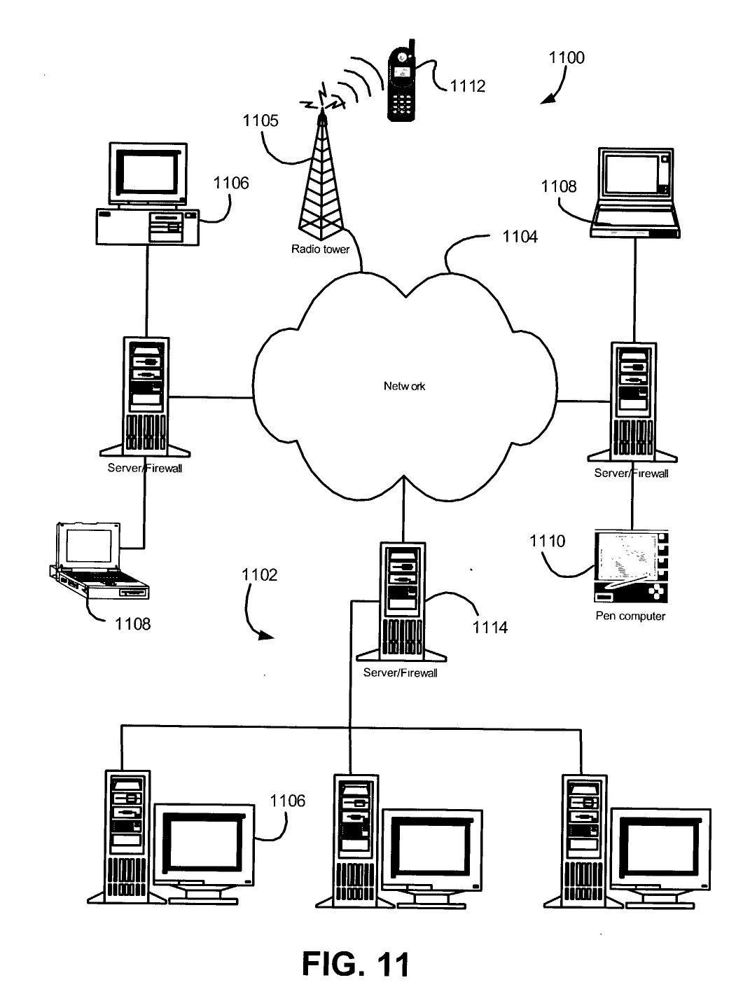

FIG. 11 illustrates an exemplary network system 1100 with a plurality of components 1102 in accordance with one embodiment of the present invention. As shown, such components include a network 1104 which take any form including, but not limited to a local area network, a wide area network such as the Internet, and a wireless network 1105. Coupled to the network 1104 is a plurality of computers which may take the form of desktop computers 1106, lap-top computers 1108, hand-held computers 1110 (including wireless devices 1112 such as wireless PDA's or mobile phones), or any other type of computing hardware/software. As an option, the various computers may be connected to the network 1104 by way of a server 1114 which may be equipped with a firewall for security purposes. It should be noted that any other type of hardware or software may be included in the system and be considered a component thereof.

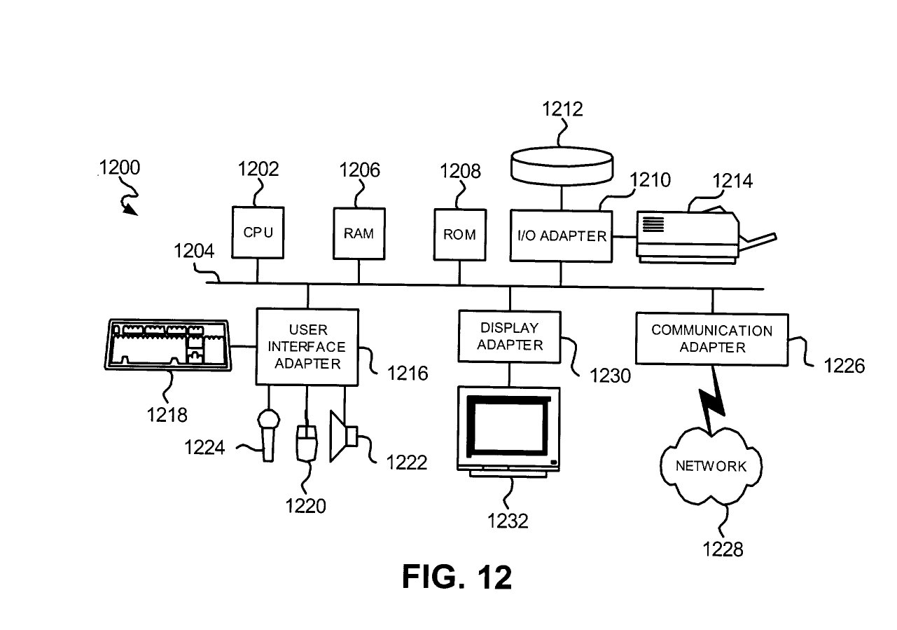

A representative hardware environment associated with the various components of FIG. 11 is depicted in FIG. 12. In the present description, the various sub-components of each of the components may also be considered components of the system. For example, particular software modules executed on any component of the system may also be considered components of the system. In particular, FIG. 12 illustrates an exemplary hardware configuration of a workstation 1200 having a central processing unit 1202, such as a microprocessor, and a number of other units interconnected via a system bus 1204.

The workstation shown in FIG. 12 includes a Random Access Memory (RAM) 1206, Read Only Memory (ROM) 1208, an I/O adapter 1210 for connecting peripheral devices such as, for example, disk storage units 1212 and printers 1214 to the bus 1204, a user interface adapter 1216 for connecting various user interface devices such as, for example, a keyboard 1218, a mouse 1220, a speaker 1222, a microphone 1224, and/or other user interface devices such as a touch screen or a digital camera to the bus 1204, a communication adapter 1226 for connecting the workstation 1200 to a communication network 1228 (e.g., a data processing network) and a display adapter 1230 for connecting the bus 1204 to a display device 1232. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and subassemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requester. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate, the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

Peer-to-peer is a communications model in which each party has the same capabilities and either party can initiate a communication session. Other models with which it might be contrasted include the client/server model and the master/slave model. In some cases, peer-to-peer communications is implemented by giving each communication node both server and client capabilities. In recent usage, peer-to-peer has come to describe applications in which users can use the Internet to exchange files with each other directly or through a mediating server.

IBM's Advanced Peer-to-Peer Networking (APPN) is an example of a product that supports the peer-to-peer communication model.

On the Internet, peer-to-peer (referred to as P2P) is a type of transient Internet network that allows a group of computer users with the same networking program to connect with each other and directly access files from one another's hard drives. Napster and Gnutella are examples of this kind of peer-to-peer software. Corporations are looking at the advantages of using P2P as a way for employees to share files without the expense involved in maintaining a centralized server and as a way for businesses to exchange information with each other directly.

With respect to the how Internet P2P works, a user must first download and execute a peer-to-peer networking program. After launching the program, the user enters the IP address of another computer belonging to the network. (Typically, the Web page where the user got the download will list several IP addresses as places to begin). Once the computer finds another network member on-line, it will connect to that user's connection (who has gotten their IP address from another user's connection and so on). Users may also be able to choose how many member connections to seek at one time and determine which files they wish to share or password protect.

Push (or “server-push”) is the delivery of information on the Web that is initiated by the information server rather than by the information user or client, as it usually is. An early Web service that specialized in “pushing” information rather than having it “pulled” as the result of requests for Web pages was Pointcast, a site that provided up-to-date news and other information tailored to a previously defined user profile. Marimba was a somewhat similar site (and product) that pushed information to the user on a predefined schedule.

In fact, the information pushed from a server to a user actually comes as the result of a programmed request from the client in your computer. That is, any information pusher on the Web requires that you download a client program. This program captures your profile and then periodically initiates requests for information on your behalf from the server.

Another form of push is broadcast information. In this case, the information is pushed to everyone that has access to a particular channel or frequency. Broadcast usually (but not always) involves a continuous flow of information.

A further form of “pushed” information is e-mail. Although the e-mail client in your computer has to occasionally go to your local e-mail server to “pick up” the e-mail, the e-mail arrived because someone sent it (pushed) it to you without a one-for-one request having been made.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for delivering content utilizing a master agent, comprising:
matching content between at least one broadcasting agent and at least one viewing agent based on at least one of identifications, permissions, and scheduling of the content;
providing a peer to peer connection via a network between the at least one broadcasting agent and the at least one viewing agent based the matched content; and
transmitting the matched content to the viewing agent from the broadcasting agent via the network, wherein the matched content is presented by the viewing agent to a viewer in a television channel format.

2. The method of claim 1, wherein at least one of the permissions and scheduling of the content is assigned by the broadcasting agent.

3. The method of claim 1, wherein the matched content is pulled from the broadcasting agent by the viewing agent.

4. The method of claim 1, wherein the matched content is pushed by the broadcasting agent to the viewing agent.

5. The method of claim 1, wherein the broadcast agent organizes the content into broadcast segments and links the broadcast segments to one or more channels in the television viewing format.

6. The method of claim 5, wherein the matched content comprises at least one broadcast segment, and wherein the viewer selects one of the channels to view the broadcast segment of the matched content.

7. The method of claim 1, wherein information about the viewer's use of a computer and of any connected peripherals to the computer is collected and wherein the collected information is used to provide content choices to the viewer provided via at least one of the network and any one of the connected peripherals.

8. A system for delivering content utilizing a master agent, comprising:
logic for matching content between at least one broadcasting agent and at least one viewing agent based on at least one of identifications, permissions, and scheduling of the content;
logic for providing a peer to peer connection via a network between the at least one broadcasting agent and the at least one viewing agent based the matched content; and
logic for transmitting the matched content to the viewing agent from the broadcasting agent via the network, wherein the matched content is presented by the viewing agent to a viewer in a television channel format.

9. The system of claim 8, wherein at least one of the permissions and scheduling of the content is assigned by the broadcasting agent.

10. The system of claim 8, wherein the matched content is pulled from the broadcasting agent by the viewing agent.

11. The system of claim 8, wherein the matched content is pushed by the broadcasting agent to the viewing agent.

12. The system of claim 8, wherein the broadcast agent organizes the content into broadcast segments and links the broadcast segments to one or more channels in the television viewing format.

13. The system of claim 12, wherein the matched content comprises at least one broadcast segment, and wherein the viewer selects one of the channels to view the broadcast segment of the matched content.

14. The system of claim 8, wherein information about the viewer's use of a computer and of any connected peripherals to the computer is collected and wherein the collected information is used to provide content choices to the viewer provided via at least one of the network and any one of the connected peripherals.

15. A computer program product for delivering content utilizing a master agent, comprising:
computer code for matching content between at least one broadcasting agent and at least one viewing agent based on at least one of identifications, permissions, and scheduling of the content;
computer code for providing a peer to peer connection via a network between the at least one broadcasting agent and the at least one viewing agent based the matched content; and
computer code for transmitting the matched content to the viewing agent from the broadcasting agent via the network, wherein the matched content is presented by the viewing agent to a viewer in a television channel format.

16. The computer program product of claim 15, wherein at least one of the permissions and scheduling of the content is assigned by the broadcasting agent.

17. The computer program product of claim 15, wherein the matched content is pushed by the broadcasting agent to the viewing agent.

18. The computer program product of claim 15, wherein the broadcast agent organizes the content into broadcast segments and links the broadcast segments to one or more channels in the television viewing format.

19. The computer program product of claim 18, wherein the matched content comprises at least one broadcast segment, and wherein the viewer selects one of the channels to view the broadcast segment of the matched content.

20. The computer program product of claim 15, wherein information about the viewer's use of a computer and of any connected peripherals to the computer is collected and wherein the collected information is used to provide content choices to the viewer provided via at least one of the network and any one of the connected peripherals.
